(19) United States
(12) Patent Application Publication
(10) Pub. No.: US 2025/0018944 A1
(43) Pub. Date: Jan. 16, 2025

(54) CRUISE CONTROL FOR LOW-SPEED VEHICLES

(71) Applicant: Ian Lee, Johnson City, TN (US)

(72) Inventor: Ian Lee, Johnson City, TN (US)

(21) Appl. No.: 18/627,420

(22) Filed: Apr. 4, 2024

Related U.S. Application Data
(60) Provisional application No. 63/494,022, filed on Apr. 4, 2023.

(51) Int. Cl. B60W 30/14

(52) U.S. Cl. CPC B60W 30/146; B60W 2420/20; B60W 2720/10

(57) ABSTRACT

A cruise control system for a low-speed vehicle is provided. A main control unit sets a desired vehicle speed based on a user input. When receiving an engagement position signal from a potentiometer, the main control unit reduces the power of a power input based on the desired vehicle speed and the maximum speed of the vehicle. A throttle position sensor powered by the main control unit regulates the speed of the low-speed vehicle based on the power output of the main control unit.

### CROSS-REFERENCE TO RELATED APPLICATIONS

This application claims the benefit of U.S. Provisional Patent Application Ser. No. 63/494,022 filed Apr. 4, 2023, which is hereby incorporated by reference in its entirety.

### FIELD

This disclosure relates generally to a cruise control system for low-speed vehicles. More specifically, this disclosure is related to a reduced speed cruise control for low-speed vehicles.

### BACKGROUND

Often vehicles are designed to operate at low speeds. Some examples of low-speed vehicles are golf carts, utility vehicles, off-road vehicles, and farm equipment. As used herein, a “low-speed vehicle” is any vehicle that includes a powertrain and has a maximum speed less than or equal to 45 miles per hour (mph). Low-speed vehicles may have a maximum speed of less than or equal to 25 mph, for example golf carts. A low-speed vehicle may have a fully enclosed cab, partially enclosed cab, or an open cab. A low-speed vehicle may also be capable of being registered to be operated on public streets or may be used exclusively off public streets.

There are a variety of situations in which it is desirable to operate a low-speed vehicle without having to continually press on the accelerator. By way of a first example, when driving a low-speed vehicle for extended periods of time, an operator's leg or foot may become fatigued or cramp by the constant pressure on the accelerator. By way of a second example, when driving the low-speed vehicle in an area with a speed limit, such as a public street or golf course, it may be difficult to apply a consistent pressure on the accelerator to not exceed the posted speed limit. Thus, there is a need for being able to operate a low-speed vehicle without having to press on the accelerator.

### SUMMARY

According to one aspect of the disclosed subject matter, a cruise control system for a low-speed vehicle is provided. A main control unit sets a desired vehicle speed based on a user input. When receiving an engagement position signal from a potentiometer, the main control unit reduces the power of a power input based on the desired vehicle speed and the maximum speed of the vehicle. A throttle position sensor powered by the main control unit regulates the speed of the low-speed vehicle based on the power output of the main control unit.

These and other aspects of the disclosed subject matter, as well as additional novel features, will be apparent from the description provided herein. The intent of this summary is not to be a comprehensive description of the claimed subject matter, but rather to provide a short overview of some of the subject matter's functionality. Other systems, methods, features and advantages here provided will become apparent to one with skill in the art upon examination of the following FIGUREs and detailed description. It is intended that all such additional systems, methods, features and advantages that are included within this description, be within the scope of any claims.

### BRIEF DESCRIPTION OF THE FIGURES

The features, natures, and advantages of the disclosed subject matter may become more apparent from the detailed description set forth below when taken in conjunction with the drawings in which like reference numerals indicate like features. The figures are not to be construed as limiting any of the embodiments.

FIG. 1 is a perspective view of a cruise control system and apparatus showing a main control box and a paddle attached to a steering wheel according to certain embodiments.

FIG. 2A is a wire diagram of the main control box according to certain embodiments.

FIG. 2B is a wire diagram of the components of the steering wheel according to certain embodiments.

FIG. 3 is a front view drawing of the steering wheel and components according to certain embodiments.

FIG. 4 is a back view drawing of the steering wheel and components according to certain embodiments.

FIG. 5 is a drawing of the main box opened showing the components according to certain embodiments.

### DESCRIPTION

The following description is not to be taken in a limiting sense, but is made for the purpose of describing the general principles of the present disclosure. The scope of the present disclosure should be determined with reference to the claims. Exemplary embodiments of the present disclosure may be illustrated in the drawings, like numbers being used to refer to like and corresponding parts of the various drawings. The dimensions of drawings provided are not shown to scale.

A cruise control system solution that may be used on a low-speed vehicle is provided. The system may include a paddle or controller mounted on the steering wheel that communicates with a throttle position sensor to regulate the speed of the vehicle. An operator may use the paddle instead of the accelerator to drive the vehicle and regulate the speed of the vehicle.

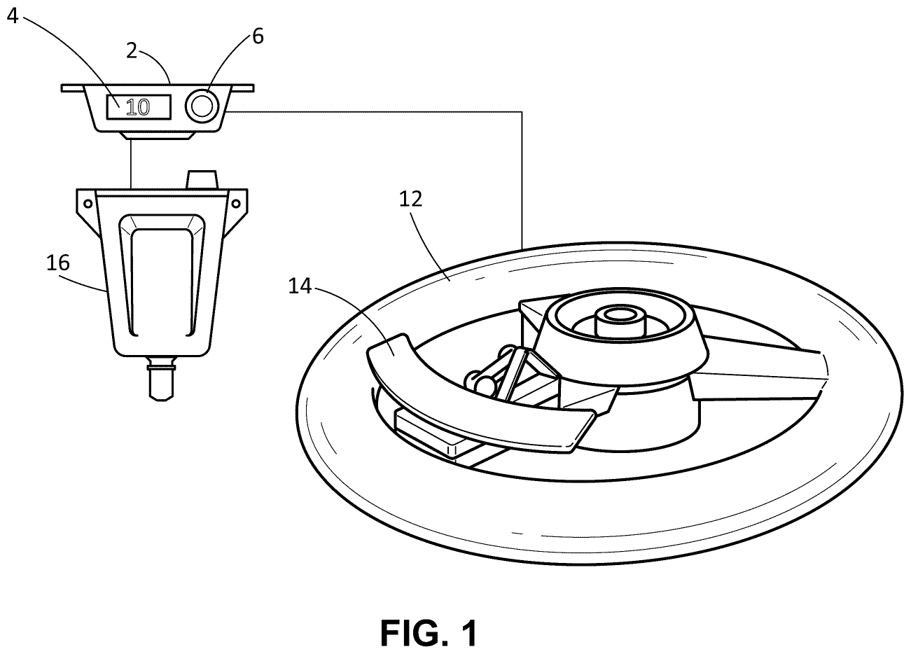

FIG. 1 is a perspective view of a cruise control system and apparatus according to any of the embodiments. The system may be used on any low-speed vehicle. Main control box 2 having speed selector knob 6 and speed selection display 4 is in communication with electronic throttle body 16 and paddle with micro-potentiometer 14 on the back of low-speed vehicle steering wheel 12.

According to any of the embodiments, the low-speed vehicle includes an electronic throttle position sensor, the throttle position sensor shown in FIG. 1 as housed in electronic throttle body 16. The throttle body may send an electronic signal that determines how much fuel or power to supply the power train. The electronic throttle body is the main housing for various throttle components such as a throttle position sensor and fuel injectors. Throttle position sensors are described herein with reference to throttle position sensors used with traditional foot accelerators on low-speed vehicles such as golf carts and particularly electrically powered golf carts. Non-limiting examples of low-speed vehicles include electric-powered vehicles or fuel-injected gas-powered vehicles. The cruise control system may also be used on cable driven vehicles with the addition of an actuator. It is to be understood that any reference to “vehicle” and all grammatical variations thereof means a low-speed vehicle. It is also to be understood that the discussion of the various embodiments applies to the systems and apparatus without the need to refer to both a system and apparatus throughout.

As defined above, the low-speed vehicle may have a maximum speed of 45 mph or 25 mph. The cruise control system may adjust the speed of the vehicle in any range from 1% to 100% of the throttle position sensor. By way of example, if the low-speed vehicle has a maximum speed of 45 mph and the speed is set to 50% of the throttle position sensor, then the vehicle will have a maximum speed of approximately 22.5 mph when the system is engaged.

The system includes a first set of components and a second set of components. The components of the cruise control apparatus may be assembled onto the low-speed vehicle as part of the manufacturing process or installed onto the vehicle after the manufacturing process, commonly referred to as aftermarket.

As shown, for example in FIGS. 1, 2B, 3, and 4, the first set of components may be located on or adjacent to a steering wheel of the low-speed vehicle.

The first set of components may include a motherboard that includes a potentiometer, for example a micro-potentiometer, and may include a wireless transmitter. The micro-potentiometer may send a position signal through the wireless transmitter or other communication device to a main control box. A power source (e.g., a battery) may supply power to the first components. A power switch may be electrically coupled to the power source such that when the switch is engaged a circuit is opened to supply the power and allow the cruise control to be used. An indicator light may illuminate when the switch is engaged to let an operator know that the cruise control may be used. The indicator light and the switch may be located at a variety of locations on the vehicle. The motherboard may also include a wireless transmitter. The wireless transmitter may be used to transmit a signal to the second set of components. A direct wired connection may also be used instead of a wireless transmitter and receiver.

The first set of components may also include a paddle. The paddle may be used by an operator to control the speed of the low-speed vehicle. The paddle may be located on a back side of the steering wheel, for example adjacent to the bottom of the steering wheel, such as at a 6 o'clock position when viewed from the driver's seat and the wheels of the vehicle are straight and not turned. To engage the vehicle for forward movement when the vehicle is in drive mode (analogous to pushing on an accelerator with one's foot), an operator may pull the paddle forwards towards themselves with their hand(s). Other actions, for example pushing the paddle away from an operator, may also be used to engage the vehicle. The vehicle may also be engaged for reverse movement when the vehicle is in reverse mode.

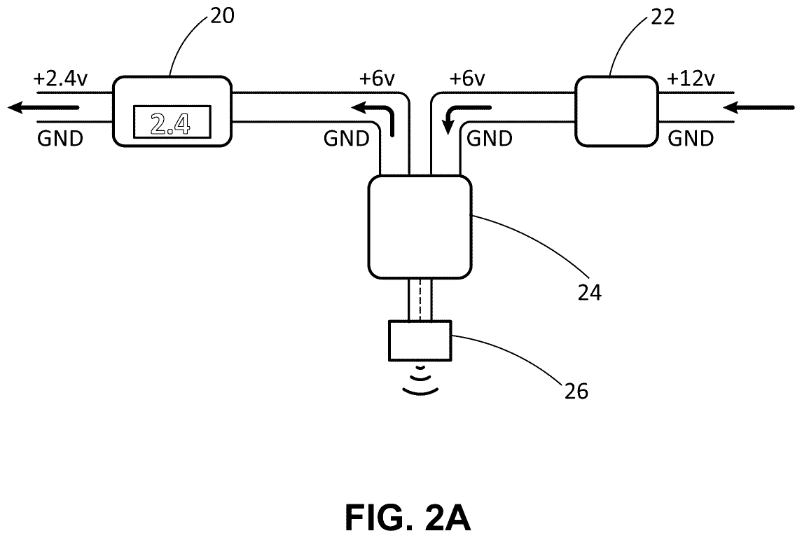

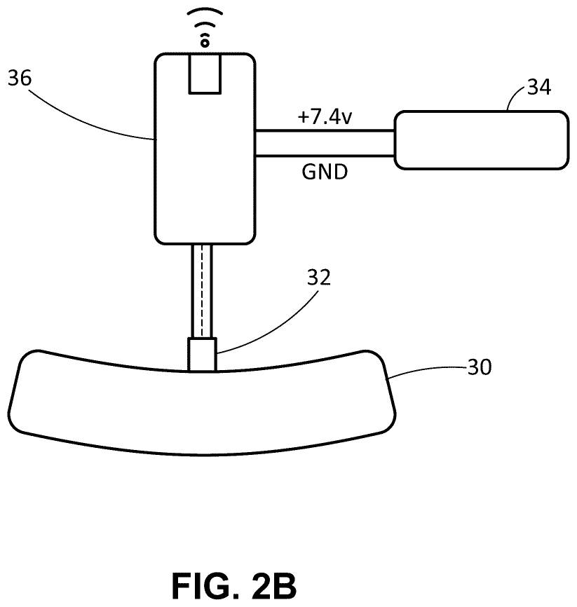

FIG. 2B is a wire diagram of an embodiment of the components of the steering wheel having paddle 30 with micro-potentiometer 32, battery pack 34, and wireless transmitter 36. When the paddle is engaged, the micro-potentiometer sends information to the microcontroller of the main control box via wireless transmitter 36 of FIG. 2B and a main control box receiver.

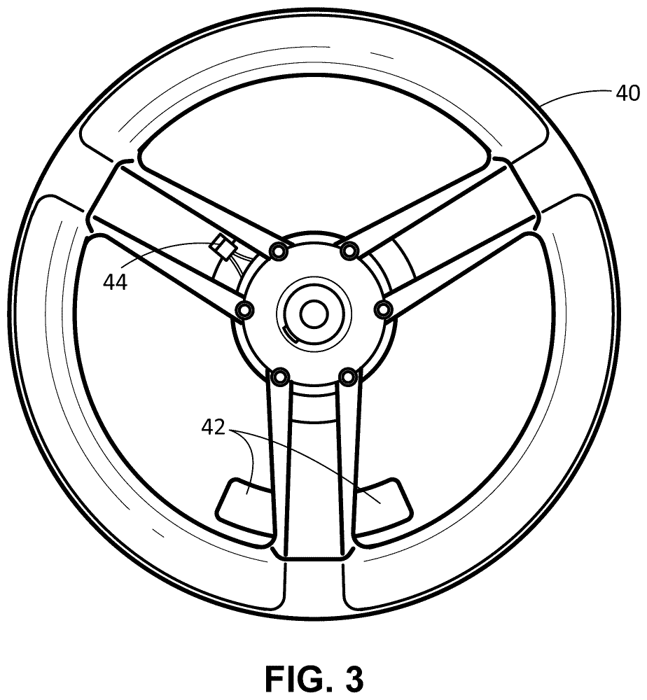

FIG. 3 is a front view drawing of steering wheel 40 and paddle 42 and the connectors of battery pack 44 to power micro-potentiometer 46.

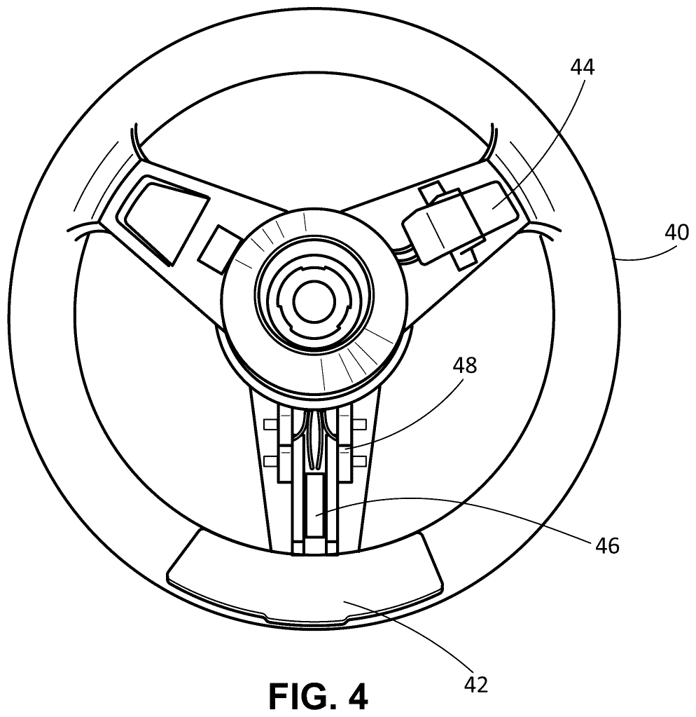

FIG. 4 is a back view drawing of the steering wheel and paddle 42, micro-potentiometer 46, wireless transmitter 48, and the body of battery pack 44.

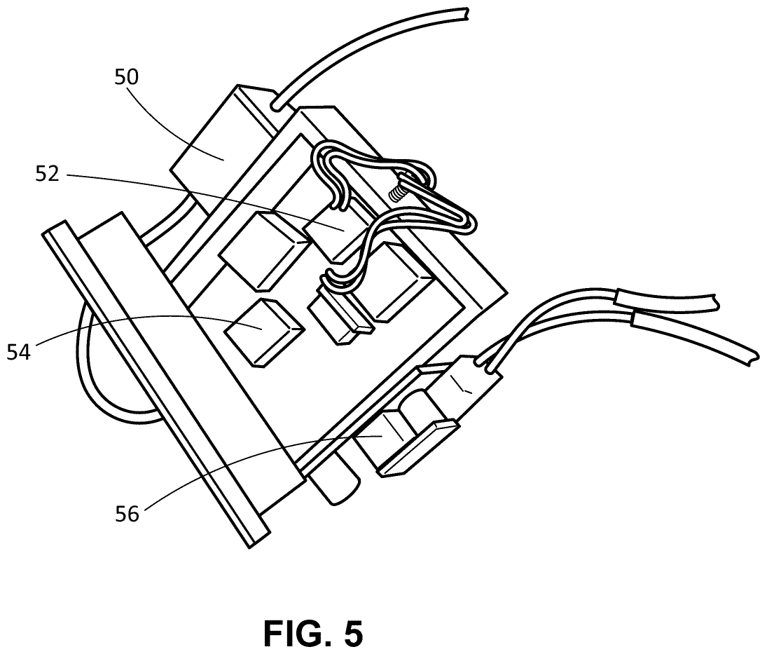

The systems also include a second set of components, as shown in FIGS. 2A and 5. The second set of components may be located at a variety of locations on the low-speed vehicle, for example near the driver's right leg. The second set of components may include a main box that houses the components. The main box may be in wired communication or wireless communication with a transmitter of the first set of components. As may be seen in FIG. 1, the second set of components in a main control box 2 may include a speed selector knob 6 and a speed selection display 4.

As may be seen in FIGS. 2A and 5, power is supplied to a microcontroller. The microcontroller may be configured for a specific voltage, for example 12 V or 6 V. The power may be supplied from a battery or other power source. The second set of components may also include a voltage reducer that reduces the power input to the correct voltage. By way of example, if the power source is 12 V and the micro-controller operates at 6 V, then the voltage reducer may reduce the voltage going to the microcontroller from 12 V to 6V.

A microcontroller may be in communication with a receiver, for example a wireless receiver. The receiver may receive information from the micro-potentiometer via the transmitter and relay that information to the microcontroller. The microcontroller then relays the information to a step-down converter, which sends power to the throttle position sensor.

FIG. 2A is a wire diagram of the main control box having step-down converter 20, voltage reducer 22, microcontroller 24, and wireless receiver 26.

FIG. 5 is a drawing of an opened main control box having voltage reducer 50, wireless receiver 52, microcontroller 54, and step-down convertor 56.

The systems may be used in a variety of ways. By way of a first example, an operator (i.e., a user) of a low-speed vehicle having a maximum speed of 25 mph may want to set the top speed to 20 mph, for example to obey speed limits when driving. Accordingly, the speed selector knob may be manually adjusted until the speed selection display shows 20 mph. An operator may engage the power switch such that the indicator light is illuminated. The operator may start the vehicle and place the gear selector in drive mode. The operator does not need to depress the accelerator with their foot to engage the vehicle, but instead, engages the paddle by moving the paddle in a direction. When the paddle is engaged, the micro-potentiometer sends information to the microcontroller via the transmitter and receiver. According to this example, 20 mph of the maximum speed of the vehicle of 25 mph is 80%. The microcontroller therefore sends information to the step-down converter to reduce the voltage and power to the throttle position sensor by 80%. Accordingly, if the voltage to the step-down converter is 6 V, then the step-down converter reduces the voltage to the throttle position sensor to 80%, which is 4.8 V. The voltage correlates to the speed of the vehicle. In this manner, even with the paddle fully engaged, the vehicle will not go above 20 mph even though the vehicle is capable of achieving a maximum speed of 25 mph. As discussed above, the percentage reduction may be anywhere from 1% to 100% of the throttle position sensor. When the paddle is released from engagement, the micro-potentiometer no longer receives an input and the vehicle will come to a stop. By way of example, an electric golf cart may include regenerative braking that will engage when the throttle is not in use. This is caused by the motor resisting the current caused by the wheels still rolling and redirects the energy back into the battery. In the case of non-electric vehicles, a driver may need to depress the brake for the vehicle to come to a stop after the paddle is disengaged.

The systems may be configured such that a single speed may be set, for example, via the speed selector knob. The single speed may be achieved and maintained by any engagement of the paddle. Thus, a desired speed can be selected and engagement of the system maintains the vehicle at the selected speed.

The systems may also be configured such that a range of speeds (e.g., between 10 and 25 mph) may be achieved by increased or decreased engagement of the paddle. For example, partial engagement (e.g., slightly pulling the paddle back towards the operator) may result in the vehicle traveling at 10 mph, while at the other end of the range, full engagement may result in the vehicle traveling at 25 mph. According to this example, the step-down converter may not be needed. There may also be more than one paddle located opposite each other, for example a first paddle at the 3 o'clock position and a second paddle at the 9 o'clock position, for example, on the steering wheel. In order to increase the speed of the vehicle, the first paddle may be engaged; and in order to decrease the speed of the vehicle, the second paddle may be engaged.

Thus, in operation, the present disclosure describes a cruise control system for a low-speed vehicle having a main control unit configured to reduce the power from a power input based on a ratio of the desired vehicle speed and the maximum speed of the vehicle and when receiving an engagement position signal, the main control unit sending the reduced power as a power output. A potentiometer for sending an engagement position signal to the main control unit based on user input when the potentiometer is powered on and engaged. And, a throttle position sensor powered by the main control unit and configured to regulate the speed of the low-speed vehicle based on the power output of the main control unit.

The low-speed vehicle can include a variety of components. The systems and apparatus can include a variety of other components. Each component in the systems and apparatus disclosed can also have other functions, connections, parts, etc. Any of the components may also be included in a housing.

As used herein, the words “comprise,” “have,” “include,” and all grammatical variations thereof are each intended to have an open, non-limiting meaning that does not exclude additional elements or steps. While the apparatus, systems, and methods are described in terms of “comprising,” “containing,” or “including” various components or steps, the apparatus, systems, and methods also can “consist essentially of” or “consist of” the various components and steps. It should also be understood that, as used herein, “first,” “second,” and “third,” are assigned arbitrarily and are merely intended to differentiate between two or more sets of components, etc., as the case may be, and does not indicate any sequence. Furthermore, it is to be understood that the mere use of the word “first” does not require that there be any “second,” and the mere use of the word “second” does not require that there be any “third,” etc.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent(s) or other documents that may be incorporated herein by reference, the definitions that are consistent with this specification should be adopted.

The foregoing description of the exemplary embodiments is provided to enable any person skilled in the art to make or use the claimed subject matter. Various modifications to these embodiments will be readily apparent to those skilled in the art, and the generic principles defined herein may be applied to other embodiments without the use of the innovative faculty. Thus, the claimed subject matter is not intended to be limited to the embodiments shown herein but is to be accorded the widest scope consistent with the principles and novel features disclosed herein.

What is claimed is:

1. A cruise control system for a low-speed vehicle, comprising:
a main control unit having a speed selector for setting a desired vehicle speed equal to or less than the maximum speed of the vehicle, said main control unit having a power input and a step down convertor for reducing the power from said power input based on said desired vehicle speed and when receiving an engagement position signal, said main control unit sending the power as a power output;
a potentiometer for sending an engagement position signal to said main control unit based on user input when said potentiometer is powered on and engaged; and,
a throttle position sensor powered by said main control unit and regulating the speed of said low-speed vehicle based on said power output of said main control unit.

2. The cruise control system of claim 1, wherein potentiometer is a micro-potentiometer.

3. The cruise control system of claim 2, wherein said micro-potentiometer is located on the steering wheel of the low-speed vehicle.

4. The cruise control system of claim 1, wherein said potentiometer is powered by a battery.

5. The cruise control system of claim 1, wherein said engagement position signal is sent from said potentiometer to said main control unit via wireless communication.

6. The cruise control system of claim 1, wherein said engagement position signal is sent from said potentiometer to said main control unit via wired communication.

7. A cruise control system for a low-speed vehicle, comprising:
a main control unit configured to reduce the power from a power input based on a ratio of a desired vehicle speed and the maximum speed of the vehicle and when receiving an engagement position signal, said main control unit sending the reduced power as a power output;
a potentiometer for sending an engagement position signal to said main control unit based on user input when said potentiometer is powered on and engaged; and,
a throttle position sensor powered by said main control unit and configured to regulate the speed of said low-speed vehicle based on said power output of said main control unit.

8. The cruise control system of claim 7, wherein potentiometer is a micro-potentiometer.

9. The cruise control system of claim 8, wherein said micro-potentiometer is located on the steering wheel of the low-speed vehicle.

10. The cruise control system of claim 7, wherein said potentiometer is powered by a battery.

11. The cruise control system of claim 7, wherein said engagement position signal is sent from said potentiometer to said main control unit via wireless communication.

12. The cruise control system of claim 7, wherein said engagement position signal is sent from said potentiometer to said main control unit via wired communication.
